(19) United States
(12) Patent Application Publication
(10) Pub. No.: US 2008/0127992 A1
(43) Pub. Date: Jun. 5, 2008

(54) Array of Dental Flossers Coupled to Each Other by Frangible Links

(76) Inventor: Leonard Pinchuk, Miami, FL (US)

Correspondence Address: GORDON & JACOBSON, P.C., 60 LONG RIDGE ROAD, SUITE 407, STAMFORD, CT, 06902, US

(21) Appl. No.: 11/564,905

(22) Filed: Nov. 30, 2006

(51) Int. Cl. A61C 15/04

(52) U.S. Cl. 132/324

(57) ABSTRACT

An array of side-by-side flossers are coupled to each other by frangible links. The user breaks off a flosser from the array prior to flossing. When finished flossing, the user disposes of the used flosser. In a preferred embodiment, the array can be about the same size as a credit card and thus can fit in a credit card pouch of a wallet.

### BACKGROUND OF THE INVENTION

1. Field of the Invention

This invention relates broadly to dental care devices. More particularly, this invention relates to an array of dental flossers coupled to each other by frangible (breakable) links.

2. State of the Art

Dental floss is basically a string which is dragged in the spaces between teeth to dislodge food and plaque and to stimulate the gums. It is believed that prehistoric humans used some form of dental floss. Several patents have been issued for improvements in dental floss, the first being issued to Johnson & Johnson Corp. in 1898. Modern dental floss is made of a bundle of synthetic filaments, typically nylon, Teflon, or polyethylene. Some types of floss are waxed. Traditionally, dental floss is provided on a spool in a container which includes a cutter. The user pulls out a length of floss from the container and cuts it to the desired length. The length of floss is then inserted into the space between adjacent teeth and, while grabbing both ends of the floss, it is dragged through, back and forth, or up and down between the teeth. The process is repeated for all of the teeth. Those who floss regularly or irregularly will appreciate that it is difficult to clean the space between molars because placement of the floss requires inserting much of one's hand into one's mouth. This is especially burdensome when a sink or other means of washing one's hands before and after use is inaccessible.

Recent improvements in dental care devices include the “flosser”. Flossers generally take the form of two spaced apart arms coupled to a handle and a length of floss extending between the arms. Unlike traditional dental floss, a flosser can be used with one hand. A known type of disposable flosser is shown in prior art FIG. 1. The flosser 1 includes a body 2 defining spaced apart arms 3 and 4 with a length of floss 5 extending therebetween. A handle 6 extends away from the body and terminates with a sharp toothpick 7. Although the flosser 1 has many good qualities such as being easy to use and combining floss and a tooth pick in the same device, it has some disadvantages. If carried in one's pocket, the sharp toothpick end can damage the pocket or become dull. If stored in a bag or purse, the flosser moves around and may be difficult to locate. Also, while a single flosser is typically thin enough to be stored in a traditionally sized man's or woman's wallet (“wallet”), a stack of flossers would be too thick.

### SUMMARY OF THE INVENTION

It is therefore an object of the invention to provide a plurality of dental flossers which can fit in a wallet, credit or business card holder, cosmetic case, and the like.

In accord with these objects, which will be discussed in detail below, the invention provides an array of side-by-side flossers which are coupled to each other by frangible links. The user breaks off a flosser from the array prior to flossing. When finished flossing, the user disposes of the used flosser.

In a preferred embodiment, the flossers are thin and are arranged side-by-side to resemble the size of a credit card. The array will thus fit in a credit card pouch of a wallet without altering its shape or making it uncomfortable to carry. In a wallet, the flossers are easy to find and their sharp ends do not endanger pockets.

Additional objects and advantages of the invention will become apparent to those skilled in the art upon reference to the detailed description taken in conjunction with the provided figures.

### BRIEF DESCRIPTION OF THE DRAWINGS

FIG. 1 is a plan view of a prior art flosser; and

FIG. 2 is a plan view of an array of flossers according to the invention.

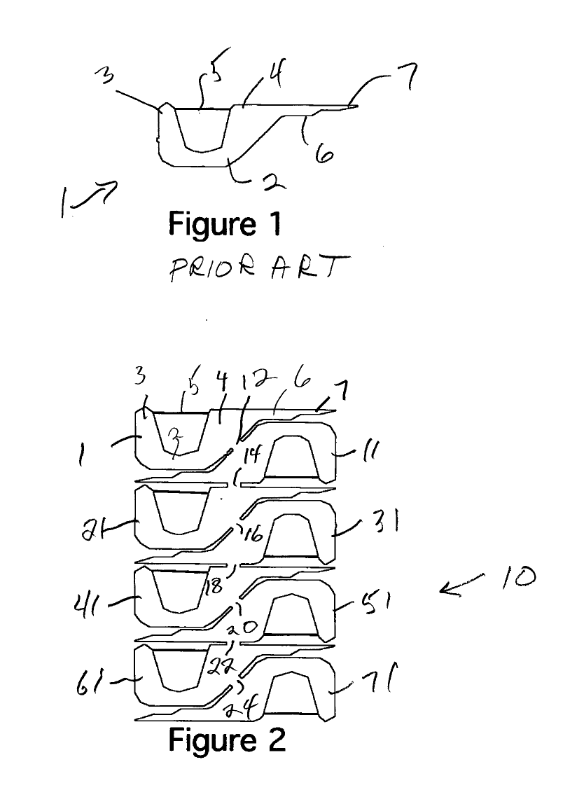

### DETAILED DESCRIPTION

Turning now to FIG. 2, a flosser array 10 according to the invention includes a plurality of substantially identical flossers 1, 11, 21, 31, 41, 51, 61, 71. The flossers are like the prior art flosser 1 having a body part 2 with spaced arms 3 and 4 holding a piece of floss 5 therebetween, and a handle part 6 terminating in a pick 7. The center of the body 2 is spaced from the floss 5 to permit the floss to be pushed through a gap between adjacent teeth (not shown). The flossers are arranged in an alternating manner, with each flosser rotated 180° relative to an adjacent flosser so that they assume a compact configuration. A small frangible bridge (link) 12, 14, 16, 18, 20, 22, 24 couples each flosser to its neighbor. As shown in FIG. 2, the links are located at central areas along the lengths of the flossers (e.g., on the body 2 near arm 4) with some of the links (e.g., 12, 16, 20, 24) angled relative to the longitudinal axes of the flossers (e.g., as may be defined by the edge of the pick), and some of the links (e.g., 14, 18, 22) arranged perpendicularly relative to the longitudinal axes.

The flosser array 10 can be made through a process of lamination and die cutting as described in U.S. Pat. No. 5,246,021. Alternatively, the array can be made by injection molding or by insert molding the flosser body around the floss. The individual flossers preferably have the same or similar thickness as a credit card and the array 10 preferably has an overall dimension substantially similar to a credit card (e.g., approximately 3.4 inches by 2.1 inches, plus or minus 20% in each direction).

The flossers can be made of any material suitable to make flossers and the floss 5 can be made of any material suitable for ordinary dental floss. Although the illustrated embodiment shows one frangible link coupling each flosser to another, more than one frangible link could be provided. However, a single link is preferred because the link can be easily broken by twisting the flossers. It will also be appreciated that the thickness and width of the frangible links should be such that the flossers are easily separated by the user but do not come apart accidentally. Furthermore, since the flossers have a substantial amount of planar space defining the arms and the handles, they could be imprinted with advertising, trademarks, or decorative designs. The flosser array 10 is preferably packaged in a pouch which keeps the flossers clean and the tips intact.

There have been described and illustrated herein an array of dental flossers coupled to each other by frangible links. While a particular embodiment of the invention has been described, it is not intended that the invention be limited thereto, as it is intended that the invention be as broad in scope as the art will allow and that the specification be read likewise. Thus, while an array of eight flossers has been shown, the array may include more or fewer flossers. Also, while the flossers are shown provided with picks, it will be appreciated that picks are not required. Further, while the flosser is shown with the floss being located coaxial with the handle and pick, it will be appreciated that the floss could be angled relative to the handle. In addition, while the flossers are shown with a single link between adjacent flossers, it will be appreciated that multiple links could be utilized. Lastly, though the flosser card shows the toothpick end being collinear with the floss end of the adjacent flossers, the toothpick end can also be indented relative to the other flossers to prevent it from snagging or rubbing against the package that contains it. It will therefore be appreciated by those skilled in the art that yet other modifications could be made to the provided invention without deviating from its spirit and scope as claimed.

1. A dental care apparatus, comprising:
a plurality of dental flossers coupled to each other by at least one frangible link, wherein
said plurality of flossers are arranged in an alternating manner so that a handle of a first flosser is opposite a body of an adjacent second flosser and vice versa.

2. The apparatus according to claim 1, wherein:
each of said plurality of flossers comprises a body defining spaced apart arms with a length of floss extending therebetween and a handle extending away from the body.

3. The apparatus according to claim 2, wherein:
each said handle terminates with a sharp tooth pick.

4. (canceled)

5. A dental care apparatus, comprising:
a plurality of dental flossers coupled to each other by at least one frangible link, wherein
said plurality of flossers are arranged in an alternating manner so that a handle of a first flosser is opposite a body of an adjacent second flosser and vice versa, and
said plurality of dental flossers have an overall dimension substantially similar to that of a traditional credit card.

6. The apparatus according to claim 5, wherein:
said plurality of dental flossers comprises at least four flossers, and said at least one frangible link comprises at least three frangible links.

7. The apparatus according to claim 6, wherein:
said at least four flossers comprises eight flossers, and said at least three frangible links comprises at least seven frangible links.

8. The apparatus according to claim 2, wherein:
said at least one frangible link links a body of a first of said plurality of flossers with a body of a second of said plurality of flossers.

9. The apparatus according to claim 8, wherein:
said at least one frangible link is located central to said plurality of flossers.

10. The apparatus according to claim 9, wherein:
said at least one frangible link is located between an arm of said first flosser and an arm of said second flosser.

11. The apparatus according to claim 9, wherein:
said at least one frangible link is oriented at an angle relative to a handle of said first flosser.

12. The apparatus according to claim 9, wherein:
said at least one frangible link is oriented perpendicularly relative to a handle of said first flosser.

13. A dental care apparatus, comprising:
at least four dental flossers arranged in an array, with adjacent flossers coupled to each other by at least one frangible link, each of said at least four flossers comprising a body defining spaced apart arms with a length of floss extending therebetween and a handle extending away from the body, said flossers being arranged in an alternating manner so that a handle of a first flosser is opposite a body of an adjacent second flosser and vice versa.

14. A dental care apparatus according to claim 13, wherein:
each frangible link links a body of a first of one of said flossers with a body of another of said flossers.

15. The apparatus according to claim 14, wherein:
each frangible link is located central to said flossers.

16. The apparatus according to claim 15, wherein:
at least one frangible link is oriented at an angle relative to a handle of one of said flossers and a second frangible link is oriented perpendicularly relative to said handle of one of said first flossers.

17. The apparatus according to claim 13, wherein:
said plurality of dental flossers have an overall dimension substantially similar to that of a traditional credit card.
